(19) United States
(12) Patent Application Publication
(10) Pub. No.: US 2020/0374260 A1
(43) Pub. Date: Nov. 26, 2020

(54) Acapella and Literature Text Messaging Mobile Device Software Application

(71) Applicant: Steven Lee Brewer, Charles Town, MD (US)

(72) Inventor: Steven Lee Brewer, Charles Town, MD (US)

(21) Appl. No.: 16/423,016

(22) Filed: May 26, 2019

(51) Int. Cl. H04L 12/58; G10H 1/00

(52) U.S. Cl. CPC H04L 51/38; H04L 51/08; G10H 2220/011; G10H 1/0008; H04L 51/10

(57) ABSTRACT

An acapella and literature mobile device messaging software application is disclosed. The invention being comprised of a messaging service that allows users to replace text with popular, digital acapella lyrics and literature passages. Users subscribe to the service and download the multimedia files to their device by means of a website or ‘App Store’ service. The application having an algorithm that searches the local multimedia files, extracts lyrics and literature based on the text string entered and replacing text with said lyrics and literature being transmitted to another user. An object of the invention is to enhance the emotional impact of the text messaging experience.

### CROSS-REFERENCE TO RELATED APPLICATIONS

This application claims the benefit of U.S. Provisional Patent Application No. 62/763,192 filed on Jul. 16, 2018.

### FIELD OF THE INVENTION

The present invention generally relates to mobile device application software. More specifically, it relates to an enhancement for text messaging.

### BACKGROUND

The first text message was sent using a desktop computer and a land line-based modem. In 1992 Neil Papworth, a former developer at Sema Group Telecoms™, typed the message “Merry Christmas” on a desktop computer that was successfully sent to Richard Jarvis at a company called Vodafone™. Most early Global System for Mobile communication mobile phone handsets did not support the ability to send text messages. The first Short Message Service (SMS) gateways for cellphones consisted of network notifications—usually to inform of voice mail messages. The Nokia™ company was the first hcell phone manufacturer to support SMS text messaging as a service and latert became the first manufacturer to produce a mobile phone with a full keyboard. As smartphones evolved in the early 2000s, touch screens allowed SMS and texting to become widely popular and easy to use and included features such as automatic spell check and correction, predictive text and emojis. Emojis in particular allowed users to express emotions that made text messaging more effective. Currently, text messaging applications have started to include multimedia options for users. Chinese Patent No. 106559469(A) developed a method for including music into text messages. Chinese Patent No. 105119815(A) and CN104796316 also disclosed a means for incorporating music files into text applications. International Patent No. 2009019628(A1) allows users to listen to music files while a text application is in process. While several patents were found that incorporate music files into text messaging, none were found that automatically searched local multimedia files for lyrics and literature passages based on text message strings and incorporated them into a text message.

### SUMMARY OF THE INVENTION

The device herein disclosed and described provides a solution to the shortcomings in the prior art through the disclosure of a text messaging mobile device software application that enhances conventional text messages.

An object of the invention is to allow such messages to become more dynamic and effective at expressing a user's emotions to a receiving party by means of a melody. For example, a cell phone user decides to send a text message to a loved one far away. They begin to enter text into their smart phone such as “I miss holding your hand.” The invention automatically searches lyric files on the phone until a match was found. The software then replaces the text message with an acapella version of the lyrics “I Wanna Hold Your Hand.”

An object of the invention is to allow such messages to become more dynamic and effective at expressing a user's emotions to a receiving party by means of a literature or poetry passage. In another example, the user begins entering text about flowers such as “I would like to give you a rose . . . ” The invention would automatically search literature files on the phone until a match is found with a passage. The software would then make a suggestion that the user incorporate a literature string such as “A Rose by Any Other Name.”

Another object of the invention is to provide for automatic ‘music-matching’ for a specific text message. The invention contains a lyric library and algorithms within the software ‘scrape’ said database to acquire lyrics matches based on a user's message.

Another object of the invention is to provide for automatic ‘poetry-matching’ for a specific text message. The invention contains a lyric library and algorithms within the software ‘scrape’ said database to acquire text matches based on a user's message.

Another object of the invention is to provide users with suggestions for the various music and poetry matches so that they can select the most appropriate replacement.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention in operation with users.

FIG. 2 shows a representative diagram of the invention.

FIG. 3 shows a flow diagram of the invention processes.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

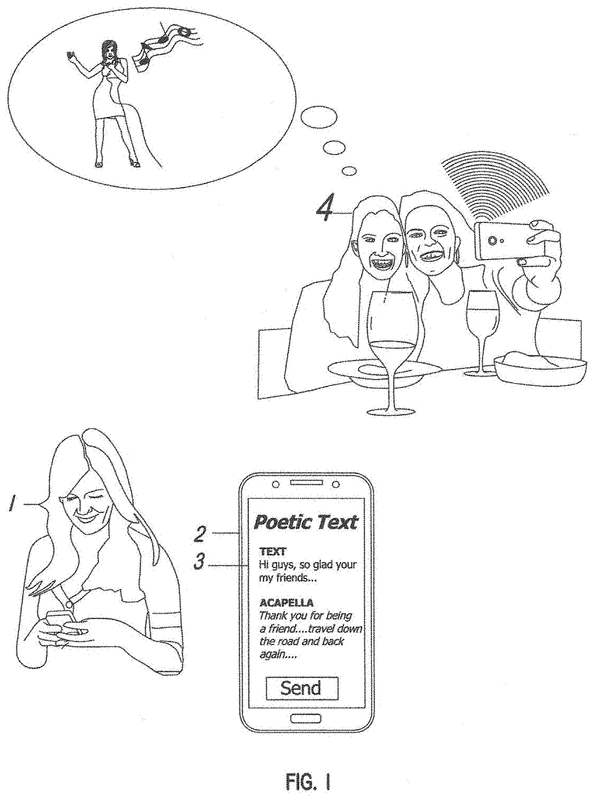

FIG. 1 shows a perspective view of the invention in operation. Said invention comprised of a software application 3 for mobile devices 2. The aforementioned invention software being written from code that may include, but not be limited to: Java™, C++™, Visual Basic™, Fortran™, Basic™ and the like. The software also compatible with a plurality of operating systems such as, but not limited to: Windows™ Apple™ and Android™ and compatible with a multitude of hardware platforms such as, but not limited to: personal desktops, laptops, tablets, smartphones and the like. The figure showing user 1 completing a text message while software application 3 scraping local acapella lyric files downloaded to mobile device 2, making a lyric file recommendation and other users 4 receiving said text message and playing said recommended lyrics.

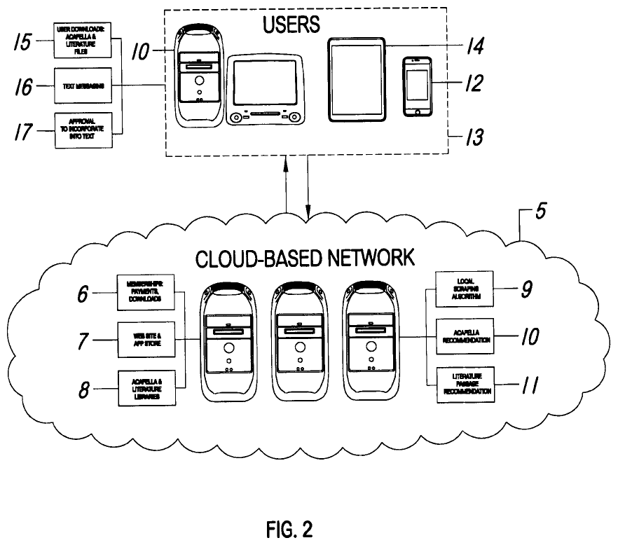

FIG. 2 shows a representative diagram of the invention including a cloud-based network 5. Said network 5 having a plurality of severs connected to a website 7 and storing software algorithms allowing membership services, payments and multimedia file downloads 6. The multimedia files comprised of acapella lyric and literature files 8. The said software also comprised of artificial intelligence (AI) algorithms that ‘scrape’ lyric and literature files for lyrics and passages that match text entered into the application. Once the files are identified, the software making acapella lyric and literature passage recommendations 10 and 11 respectively. The figure also showing end user compatible devices 13 interacting with said cloud network 5 including, but not limited to: desktop computers 10, tablets 14, and mobile devices 12. Lastly, FIG. 2, illustrating user inputs such as, but not limited to: downloading acapella lyric and literature files from said cloud network 5 to their local device, generating text messages 6 and providing approval to incorporate acapella and literature files into text messages 17.

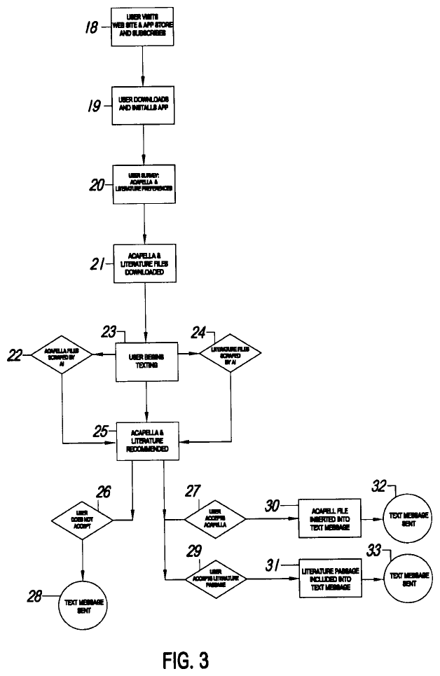

FIG. 3 shows a flow diagram of the invention processes. In step 18 the user visiting said network website or ‘App Store’ and subscribing to the invention service. Step 19 showing user downloading the aforementioned application software and installing it on a device. Once installed, the application requesting a user to complete a survey regarding their preferences relating to acapella lyrics and literature in step 20 and then said files being downloaded to the user's local device in step 21. In step 23 a user begins texting and the invention scraping acapella files in step 22 as well as literature files in step 24 and selecting similar acapella lyrics and literature passages and recommending them to the user in step 25. In step 26 a user not accepting invention requests and sends text message in step 28. In step 27 a user accepting recommended acapella lyric, allowing it to be inserted into text message in step 30 and sent to another user in step 32. In step 31 a user accepting recommended literature passage, allowing it to be inserted into text message in step 31 and sent to another user in step 33.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A mobile device messaging application comprising:
a) a cloud-based network;
b) a website;
b) acapella lyric files;
c) literature and poetry passages files; and
d) an AI scraping algorithm.

2. The acapella lyric files of claim 1 archived on the cloud-based network of claim 1.

3. The literature passage files of claim 1 archived on the cloud-based network of claim 1.

4. A method of enhancing conventional text messaging, the method comprised of:
(a) matching text messages to lyric files;
(b) matching text messages to literature and poetry passages files;
(c) providing users with choices of lyrics, literature and poetry passages to replace text messages;

5. The matching text messages to lyric files of claim 2 being performed by the AI scraping algorithm of claim 1;

6. The matching text messages to literature and poetry passages files of claim 2 being performed by the AI scraping algorithm of claim 1;
